(19) United States
(12) Patent Application Publication
(10) Pub. No.: US 2004/0130043 A1
(43) Pub. Date: Jul. 8, 2004

(54) Device for stirring and aerating a liquid in a treatment vessel

(76) Inventor: Alain Boulant, Pornichet (FR)

Correspondence Address: STEVENS DAVIS MILLER & MOSHER, LLP, 1615 L STREET, NW, SUITE 850, WASHINGTON, DC, 20036, US

(21) Appl. No.: 10/475,187

(22) PCT Filed: Apr. 17, 2002
(86) PCT No.: PCT/FR02/01315

(30) Foreign Application Priority Data
Apr. 19, 2001 (FR) 01/05293

(51) Int. Cl. B01F 3/04

(52) U.S. Cl. 261/91

(57) ABSTRACT

The invention concerns a device (10) for stirring and aerating a liquid (3) in a treatment vessel (1), comprising: at least a funnel (11); at least a casing (12) connected to said funnel (11); at least a main stirrer (13) located in said casing (12); means (14, 15) for driving said stirrer (13) in rotation; and means (17, 18) for incorporating air in said liquid, said air incorporating means consisting exclusively of means adapted to incorporate in said liquid (3) air at atmospheric pressure under the sole effect of the movement of said liquid (3) inside the device (10). Said device is characterised in that said air incorporating means include the upper edge of said funnel (11), configured so as form a cascade of liquid (3) at the periphery of said funnel (11).

The present invention relates to a device for stirring and aerating a liquid in a treatment vessel.

The document DE 34 27 174 discloses a device for stirring and aerating a liquid in a treatment vessel, comprising:

at least one funnel adapted to be disposed in the upper portion of said vessel and forming with said vessel a passage,

at least one duct connected to said funnel and adapted to extend in the direction of the bottom of said vessel, said duct including at least one opening in each of its upper and lower portions,

at least one main screw situated in said duct,

means for driving rotation of said screw, and

means for incorporating air into said liquid, said air incorporation means being constituted exclusively of means adapted to incorporate air at atmospheric pressure into said liquid exclusively because of the effect of imparting movement to said liquid in the interior of said device.

In the above prior art device, the means for incorporation of air comprise a tubular member disposed around the drive shaft of the screw, said hollow member extending between the exterior of the device and the interior of the duct.

Although they encourage the process of aeration of the liquid, in particular with a view to biodegrading it, said air incorporation means provide only a mediocre overall efficiency.

An object of the present invention is to remedy this drawback.

The above object of the invention is achieved by a device for stirring and aerating a liquid in a treatment vessel, including:

at least one funnel adapted to be disposed in the upper portion of said vessel and forming with said vessel a passage,

at least one duct connected to said funnel and adapted to extend in the direction of the bottom of said vessel, said duct including at least one opening in each of its upper and lower portions,

at least one main screw situated in said duct,

means for driving rotation of said screw, and

means for incorporating air into said liquid,

said air incorporation means being constituted exclusively of means adapted to incorporate air at atmospheric pressure into said liquid exclusively because of the effect of imparting movement to said liquid in the interior of said device,

and said device being characterized in that said air incorporation means comprise the upper edge of said funnel, conformed to form a cascade of liquid at the periphery of said funnel.

Thanks to the presence of a cascade of this kind, a large quantity of air can be incorporated into the liquid to be treated without it being necessary to use any additional input of energy.

Thus the overall efficiency of the aeration and stirring device can be significantly improved.

According to other features of the device according to the invention:

said funnel has a substantially conical bottom surmounted by a substantially cylindrical belt defining said rim,

said air incorporation means comprise a plurality of projections distributed over the upper edge of said funnel;

said air incorporation means comprise an annular member inside said funnel;

said annular member takes the form of an annular trough;

said annular member takes the form of an annular grid;

-said duct extends above the upper edge of said funnel and said air incorporation means comprise at least one window formed in the upper portion of said duct;

said air incorporation means comprise anti-vortex means disposed inside said duct above said main screw;

said air incorporation means comprise an accelerator of the liquid inside said duct;

said air incorporation means comprise means for aerating the surface of said liquid;

said air incorporation means comprise a vortex pump inside said duct;

said air incorporation means comprise a single-passage screw inside said duct;

said air incorporation means comprise a two-passage screw inside said duct;

said main screw is of the mainly axial flow type;

said device includes anti-vortex means disposed inside said duct below said main screw;

said device comprises dynamic stirring means;

said device comprises static stirring means for creating turbulence disposed inside said duct;

said device comprises means for aspirating foam formed on the surface of said liquid into the interior of said duct.

The present invention also consists in a liquid treatment vessel equipped with a device according to any one of the preceding claims [sic].

Other features and advantages of the present invention will become apparent in the light of the following description and from an examination of the appended drawings, in which:

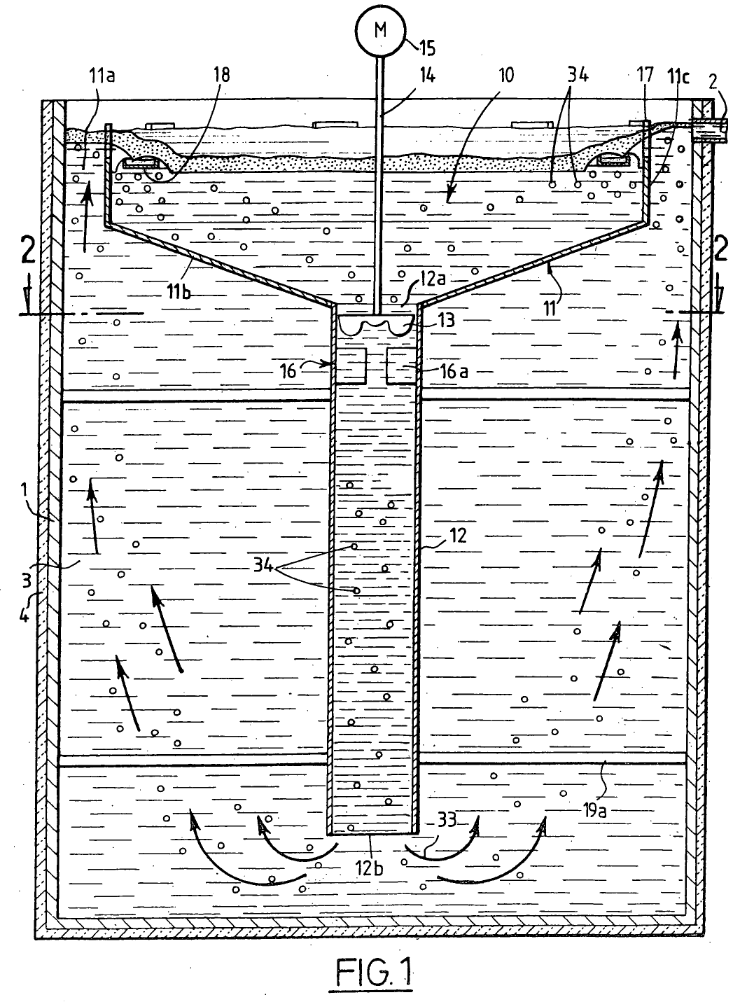

FIG. 1 is a diagrammatic view in section of a liquid treatment vessel equipped with a first embodiment of a device according to the invention,

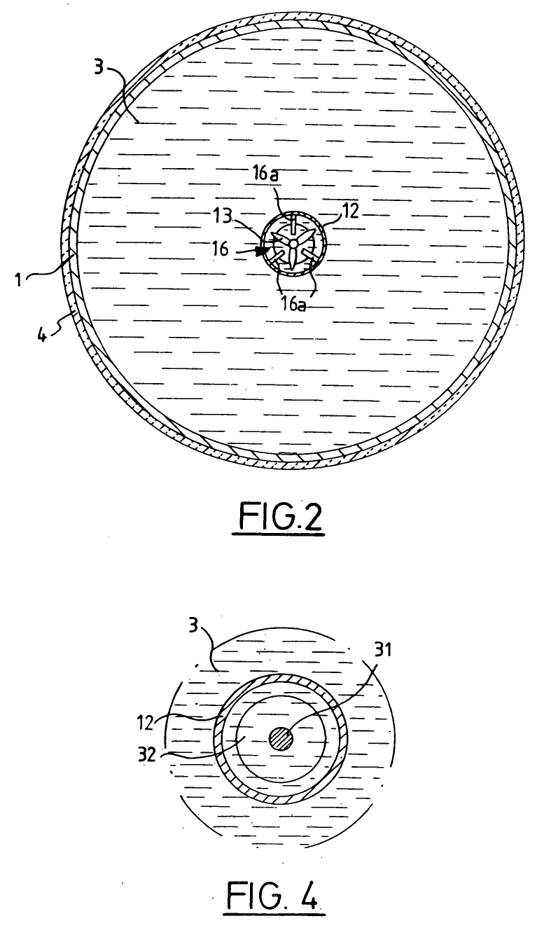

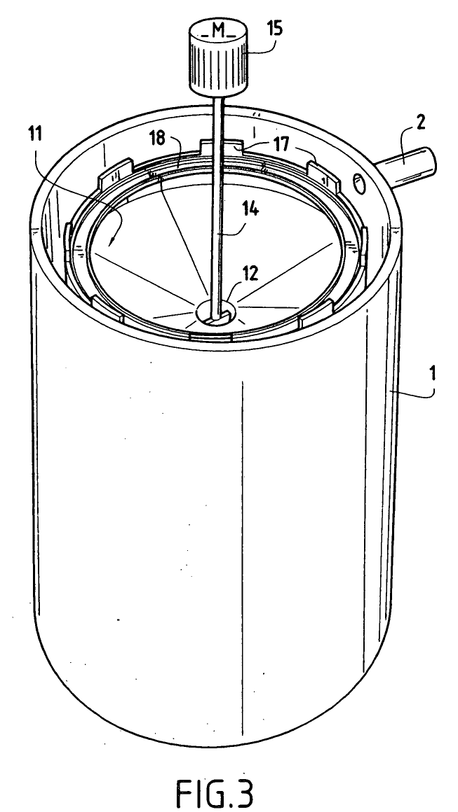

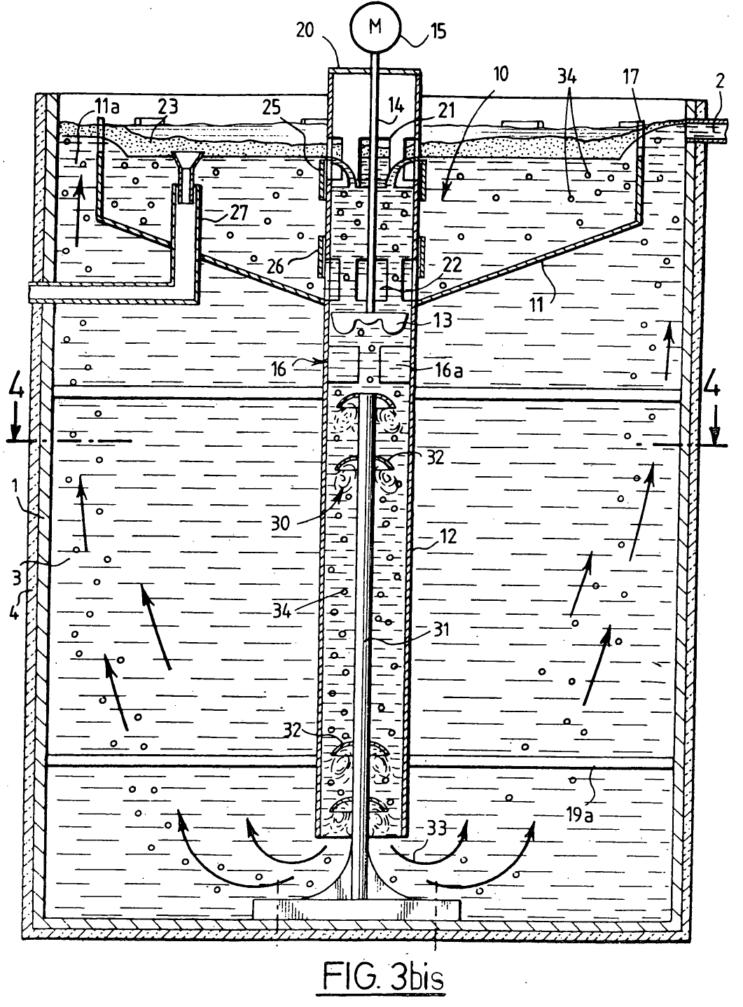

FIG. 2 is a view in section taken along the line 2-2 in FIG. 1,

FIG. 3 is a perspective view of the FIG. 1 treatment vessel,

FIG. 3bis is a diagrammatic view in section of a liquid treatment vessel equipped with a second embodiment of the device according to the invention,

FIG. 4 is a view in section taken along the line 4-4 in FIG. 3,

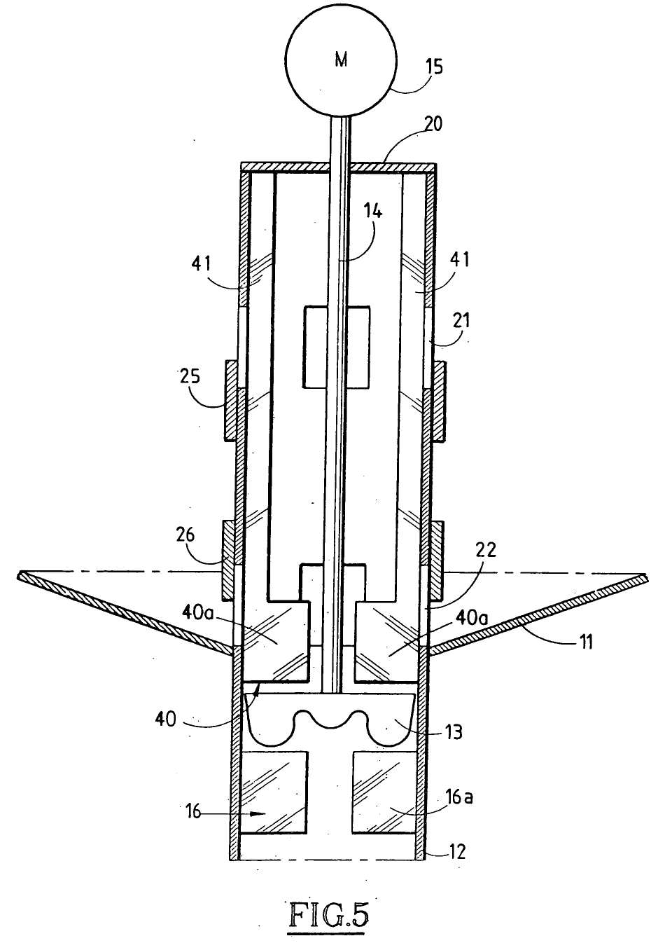

FIG. 5 is a partial diagrammatic view in section of a third embodiment of the device according to the invention,

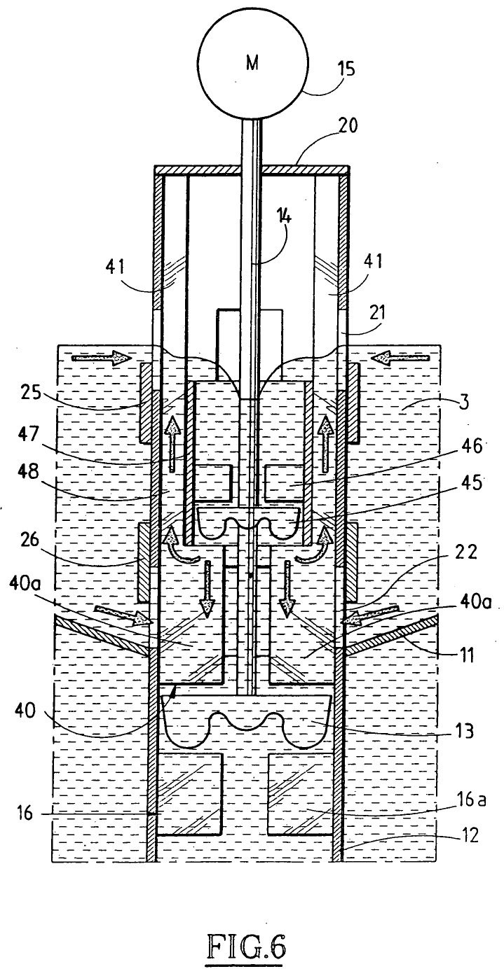

FIG. 6 is a diagrammatic view in section of a liquid accelerator associated with the third embodiment of the device according to the invention,

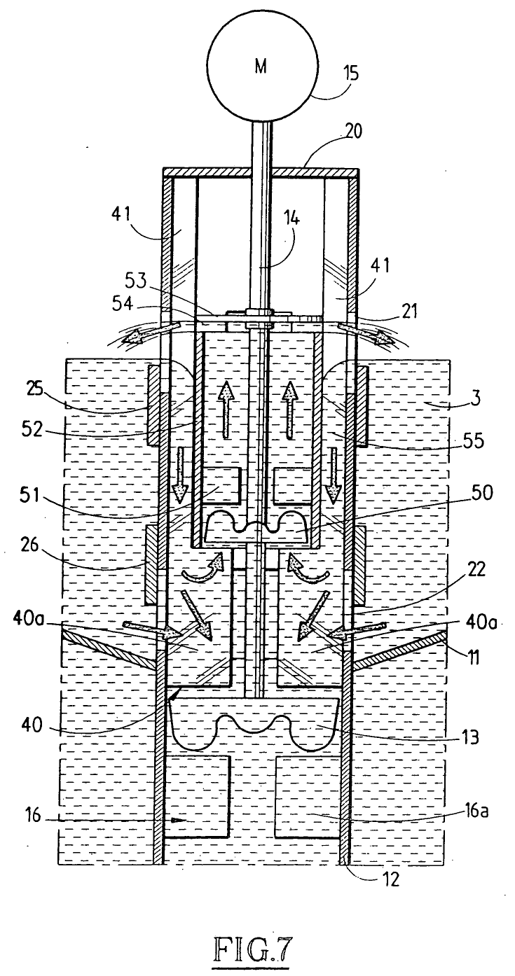

FIG. 7 is a diagrammatic view in section of means associated with the FIG. 6 accelerator for aerating the surface of the liquid,

FIG. 8 is a diagrammatic partial view in section of a fourth embodiment of a device according to the invention,

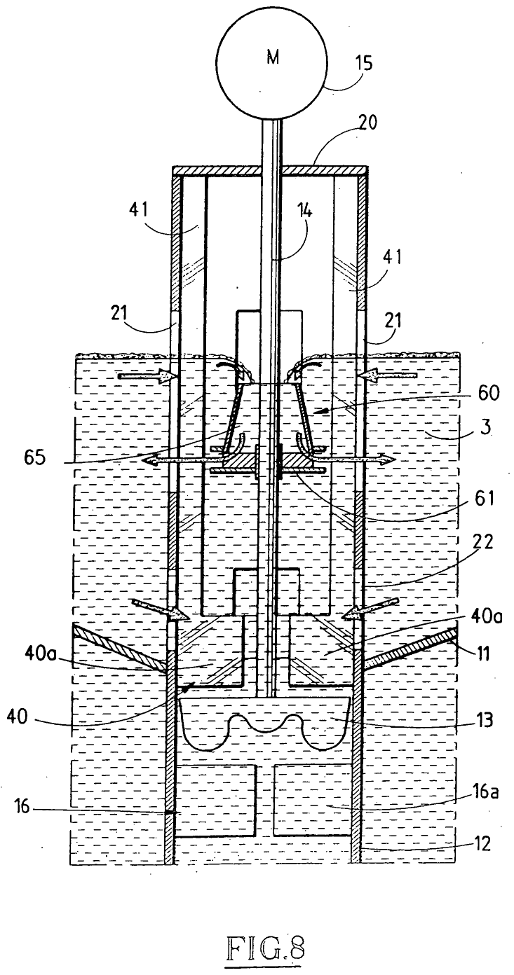

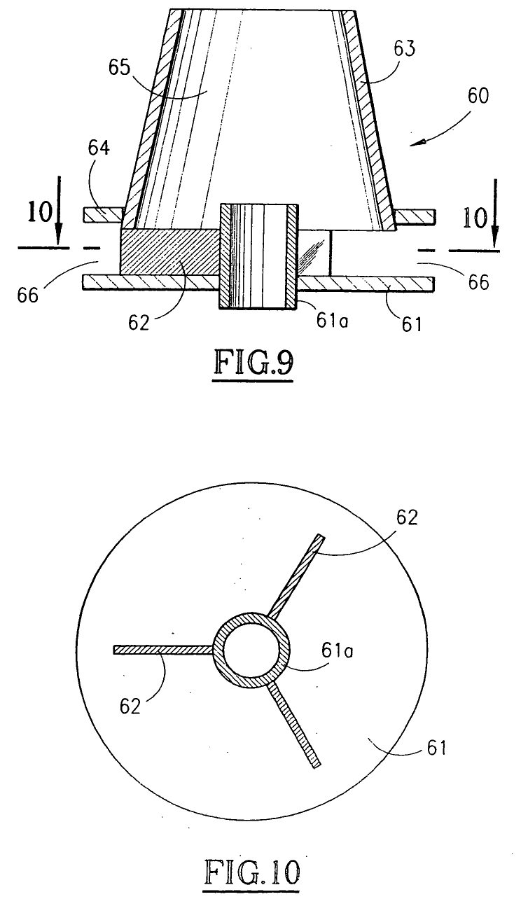

FIG. 9 is a diagrammatic view to a larger scale of the vortex pump of the fourth embodiment of the device according to the invention,

FIG. 10 is a view in section taken along the line 10-10 in FIG. 9,

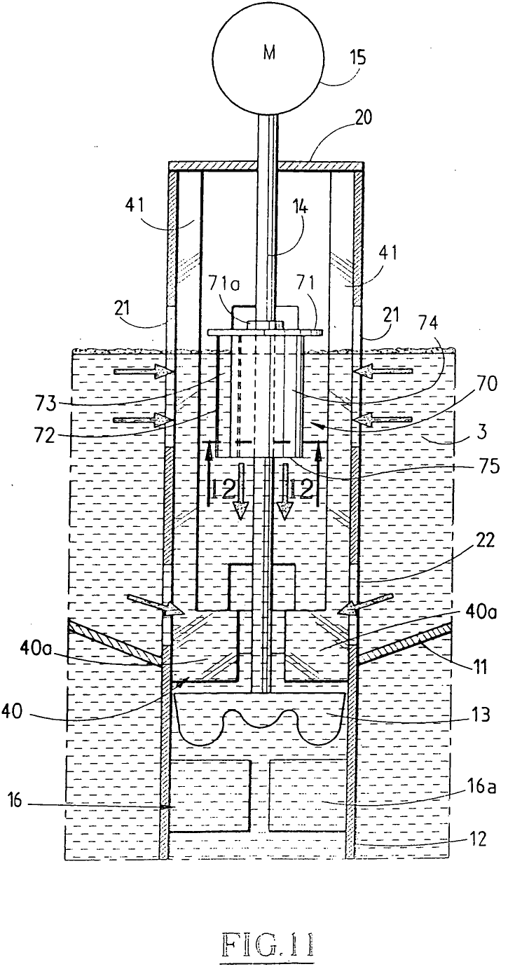

FIG. 11 is a diagrammatic partial view in section of a fifth embodiment of the device according to the invention,

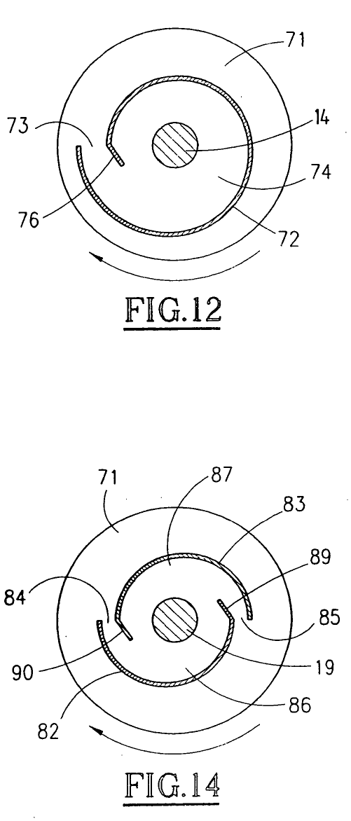

FIG. 12 is a view in section taken along the line 12-12 in FIG. 11,

FIG. 13 is a diagrammatic partial view in section of a sixth embodiment of the device according to the invention, and

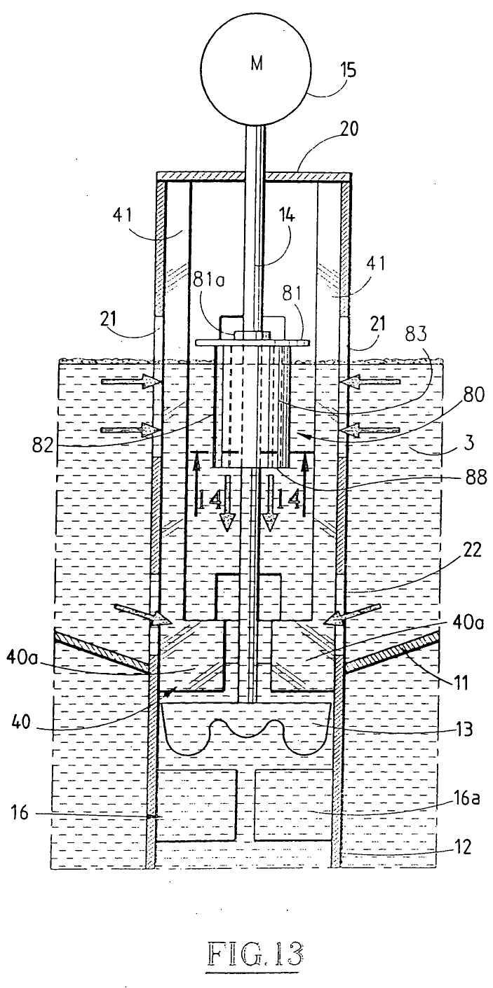

FIG. 14 is a view in section taken along the line 14-14 in FIG. 13.

In the above figures, identical reference numbers designate identical or analogous parts or sets of parts.

FIG. 1 shows a vessel 1 provided at the top with an inlet orifice 2 for a liquid 3 to be treated, such as greasy effluent extracted from urban waste water effluent, for example.

The treatment vessel 1 can be covered with insulation 4 on its external face and include a device 10 in accordance with the invention for stirring and aerating the liquid.

The device 10 is disposed inside the vessel 1 and comprises a funnel 11 that widens in the upward direction, and is placed in the upper portion of the vessel 1, and whose upper edge forms with the wall of the vessel 1 a free space 11a for the passage of the liquid 3.

Said funnel has a substantially conical bottom 11b surmounted by a substantially cylindrical belt 11c.

The device further includes a duct 12 connected to the funnel and extending in the direction of the bottom of the vessel 1, the duct having an opening 12a at the top communicating with the bottom of the funnel 11 and an opening 12b at the bottom discharging in the vicinity of the bottom of the vessel 1.

The device 10 is further provided with means for aspirating the liquid into the interior of the duct 12, comprising a main screw 13 disposed under the bottom of the funnel 11 and fixed to a vertical shaft 14 adapted to be driven in rotation by a gear motor 15.

The screw 13 is preferably of a type known in the art with mainly axial flow, i.e. of the type adapted to generate a field of velocities only slightly inclined to the axis of the screw.

This type of screw is used in particular in applications in which it is essential, for reasons of safety, to enclose the screw: because this type of screw generates a mainly axial flow, it limits the losses of energy at the enclosing walls, and thus optimizes efficiency.

This type of screw is found in tugs, for example, where it is essential to protect the screw to prevent it becoming entangled in the cables of ships to be towed.

An anti-vortex member 16 is preferably disposed inside the sleeve 12 below the screw 13 to prevent rotation of the liquid 3 in the duct 12.

As shown in FIG. 2, the anti-vortex member 16 comprises three vertical plates 16a inside said duct 12 and spaced by 120°.

There are no compressed air injection means in the device according to the invention.

As shown in FIGS. 1 and 3, the upper edge of the funnel 11 optionally comprises a plurality of projections 17, which can take the form of regularly spaced teeth.

As shown in FIGS. 1 and 3, the device 10 can also optionally include an annular member 18 inside the funnel 11, in the vicinity of its upper end.

This member can take the form of an annular trough, for example, as shown here, or an annular metal grid.

The device 10 can be connected to the interior of the vessel 1 by lugs 19a with passages for the liquid 3 between them.

Refer now to FIG. 3bis, which shows a second embodiment of the invention.

Only those features that distinguish it from the previous embodiment are described hereinafter.

The duct 12 extends higher than the upper edge of the funnel 11 and its upper end is closed by a plate 20 supporting the gear motor 15.

The duct 12 includes a first series of windows 21 uniformly distributed around its perimeter and situated at the level of the liquid 3 inside the funnel 11.

The duct 12 further includes a second series of windows 22 uniformly distributed around the perimeter of the duct 12 and situated higher than the bottom of the funnel 11.

The device 10 is provided with means for adjusting the flowrate of the liquid 3 and foam 23 aspirated by the main screw 13 into the interior of the duct 12 via the windows 21 and 22.

The aforementioned adjustment means comprise, firstly, a first sleeve 25 disposed around the duct 12 at the level of the first series of windows 21 and, secondly, a second sleeve 26 disposed around said duct 12 at the level of the second series of windows 22.

The position of each of the sleeves 25 and 26 relative to the respective windows 21 and 22 can be adjusted vertically by appropriate clamping means, not shown.

In this second embodiment, the device 10 also comprises means for regulating the level of the liquid 3 in the funnel 11.

Those means can comprise an overflow pipe 27 disposed inside the funnel 11 and whose position can be adjusted vertically.

In this second embodiment, the device 10 also comprises static means 30 disposed inside the duct 12 and below the anti-vortex member 16 for stirring the liquid 3 by creating turbulence.

As shown in FIGS. 3bis and 4, the static means 30 comprise, firstly, a vertical tube 31 disposed inside the duct 12 and extending from the bottom of the vessel 1 to the bottom of the anti-vortex member 16 and, secondly, superposed obstacles 32 disposed inside the duct 12 and fixed to the tube 31.

The tube 31 is fixed to the bottom of the vessel 1 by appropriate means.

The obstacles 32 and the internal wall of the duct 12 form passages for the circulation of the liquid.

As shown in FIG. 3bis, the obstacles 32 are preferably distributed over the tube 31, firstly, below the anti-vortex member 16 and, secondly, in the lower portion of the duct 12.

For example, the upper portion of the tube 31, below the anti-vortex member 16, includes two superposed obstacles 32 and the lower portion of the duct 12 also includes two superposed obstacles 32.

In a variant that is not shown, the obstacles 32 can be readily distributed over all of the portion of the tube 31 disposed in the duct 12.

As shown in FIG. 3bis, the obstacles 32 are preferably cups whose concave side is directed toward the bottom of the vessel 1.

In a variant that is not shown, the obstacles 32 can take the form of disks.

In another variant that is not shown, the static stirring means for creating turbulence can take the form of obstacles disposed on the internal wall of the duct 12 and forming an axial passage for the flow of the liquid 3.

The obstacles can readily be distributed over the whole of the portion of the duct 12 situated below the anti-vortex member 16 or grouped together, firstly, below the anti-vortex member 16 and, secondly, in the lower portion of the duct 12.

In this case also, the obstacles can take the form of disks or cups whose concave side is directed toward the bottom of the vessel 1.

In the second embodiment, the device 10 does not include any annular member 18 (see FIG. 3).

However, it must be understood that the invention also includes a device having the above kind of annular member in addition to the features of the second embodiment.

More generally, it must be understood that the invention includes any device for incorporating air into the liquid to be treated in which the air incorporation means are constituted exclusively of means adapted to incorporate air at atmospheric pressure into said liquid exclusively because of the effect of imparting movement to said liquid inside said device, and in which said air incorporation means comprise the upper edge of said funnel, conformed to form a cascade of liquid at the periphery of said funnel.

Thus the invention also includes a device comprising windows 21, 22 but no static stirring means 30 for creating turbulence, for example.

The invention also includes a device having dynamic means for stirring the liquid situated in the duct, conforming for example to the teaching of patent application EP 0 687 497, but not including any compressed air injection means, in contrast to what is taught by this application.

The dynamic stirring means can comprise a “long shaft”, i.e. a shaft extending under the main screw 13 inside the duct 12 and provided with means for stirring the liquid situated inside the duct 12.

The device that has just been described operates in the following manner.

The liquid 3 to be treated is discharged into the vessel 1 via the orifice 2 up to a level situated above the upper edge of the funnel 11 (see FIGS. 1 and 3bis).

The liquid 3 is also discharged into the interior of the funnel 11.

The gear motor 15 drives rotation of the shaft 14 which in turn drives rotation of the main screw 13.

The rotation of the main screw 13 causes aspiration of the liquid 3 into the duct 12 with the result that the liquid 3 flows continuously downward in the duct 12, enters the space 33 between the lower end of the duct 12 and the bottom of the vessel 1, flows upward between the duct 12 and the internal wall of the vessel 1, and so on.

The anti-vortex member 16 prevents rotation of the liquid in the duct 12 below the screw 13.

Because of the suction caused by the screw 13, the level of the liquid 3 inside the funnel 11 is below the level of the liquid inside the vessel 1.

Thanks to the particular shape of the funnel 11 (see above: a substantially conical portion 11b surmounted by a substantially cylindrical portion 11c), this results in the liquid 3 cascading over the whole of the periphery of the funnel 11, which cascade leads to the incorporation of air 34 into this liquid.

The presence of the projections 17 and/or the annular member 18 in the first embodiment (see FIGS. 1 and 3) increases the efficiency of incorporation of air into the liquid 3 in the region in which the liquid is discharged into the funnel 11.

The projections 17 separate the flow of the liquid 3 into a plurality of streams which naturally trap air on joining together again.

The annular member 18 creates a second cascade contributing to the incorporation of air.

In the second embodiment (see FIG. 3bis), the suction caused by the screw 13 also has the effect of creating an additional cascade inside the duct 12, which contributes to the incorporation of air into the liquid 3.

It will be noted that the overflow pipe 27 adjusts the level of the liquid 3 inside the funnel 11 so that it is substantially halfway up the windows 21.

It will also be noted that the windows 21 ensure that the foam 23 on the surface of the liquid 3 is drawn into the duct 12, thereby preventing the foam from flying off and polluting the environment.

It will further be noted that the flowrate of the liquid 3 can be adjusted by moving the sleeves 25 and 26 relative to the windows 21 and 22.

When the liquid 3 flows into the duct 12, turbulence is created below each of the obstacles 32, dividing the bubbles of air 34 into microbubbles, which encourages the biodegradation process, and thus improves the efficiency of the device according to the invention.

In each of the embodiments described hereinabove, the gas bubbles between the internal wall of the vessel 1 and the duct 12 accelerate upward movement of the liquid, encouraging the circulation of the liquid inside the vessel 1, which improves efficiency.

Accordingly, the liquid to be treated passes through the duct 12 several times and therefore receives several oxygenation treatments.

On each passage, the cascade originating at the edge of the funnel 11 and/or the projections 17 and/or the annular member 18 (see FIGS. 1 and 3) and/or the windows 21 (see FIG. 3bis) cause air to be incorporated into the liquid 3 exclusively by the effect of imparting movement to the liquid, this air accounting for the biodegradation of the liquid 3.

It has been realized that this incorporation of air could be sufficient to treat with satisfactory overall efficiency in particular liquids with a low charge of organic materials in relatively small vessels, and that it is not necessary to use an additional input of energy, for example in the form of injecting compressed air into the duct.

For treating charged liquids and/or for relatively large vessels, it is preferable to use a main screw 20 of the type described hereinabove, i.e. with mostly axial flow.

With this kind of screw the height that the liquid 3 forms in the funnel 11 and in the duct 12 can be increased, thereby improving the process of incorporating air into the liquid.

It also goes without saying that combining the various air incorporation means described hereinabove improves the efficiency of the device.

The rotation speed of the main screw 20 is chosen to match the operating conditions of the device according to the invention to the nature of the liquid to be treated.

Other embodiments comprising means contributing to the incorporation of air into the liquid 3 because of the effect of the cascade formed at the periphery of the funnel 11 are briefly described next.

In the third embodiment, shown in FIG. 5, the device comprises a second anti-vortex member 40 disposed inside the duct 12 and above the main screw 13.

This second anti-vortex member 40 takes the form of at least two vertical plates 40a each extended upward by a reinforcing rib 41 extending as far as the upper end of said duct 12.

The second anti-vortex member 40 preferably takes the form of four vertical plates 40a uniformly distributed inside the duct 12 and each extended upward by a reinforcing rib 41.

The second anti-vortex member 40 creates a friction force on the liquid 3 which causes agitation to facilitate the incorporation of air into the liquid 3.

In a variant shown in FIG. 6, the device comprises a liquid accelerator inside the duct 12.

This liquid accelerator takes the form of a secondary screw 45 disposed above the second anti-vortex member 40 and constrained to rotate with the shaft 14.

The pitch of the secondary screw 45 is the same as the pitch of the main screw 13.

Moreover, the liquid accelerator further comprises an anti-vortex member 46 disposed above the secondary screw 45 and inside a cylindrical chimney 47.

The chimney 47 is fixed to the internal edge of the reinforcing ribs 41 to form passages 48 for the liquid between the reinforcing ribs 41 and in conjunction with the duct 12.

The secondary screw 45, the anti-vortex member 46, and the chimney 47 are situated between the two series of windows 21 and 22 which, in this variant, are provided with adjustment sleeves 25, 26.

The rotation of the main screw 13 aspirates the liquid 3 into the duct 12 via the windows 21 and 22 and the liquid 3 therefore flows continuously downward in the duct 12.

Moreover, the rotation of the secondary screw 45 accelerates the aspiration of the liquid 3 into the duct 12 via the windows 21 and 22 and some of the liquid rises up again through the passages 48 between the duct 12 and the chimney 47, which further accentuates this phenomenon of acceleration of the liquid inside said duct 12.

The anti-vortex member 46 prevents rotation of the liquid in the chimney 47.

The acceleration and the aspiration of the liquid have the effect of subjecting it to violent agitation, encouraging the incorporation of air into the liquid.

This variant is suitable in particular for products that are especially foamy.

Foam floating on the surface of the liquid 3 is aspirated into said chimney 47 because of the acceleration of the aspiration of the liquid 3 into the interior of the chimney 47 and the recirculation of some of the liquid in the passages 48.

In a variant shown in FIG. 7, the device includes means for aerating the surface of the liquid 3 inside the vessel 1.

As shown in this figure, the means for aerating the surface of the liquid 3 take the form of a secondary screw 50 disposed above the second anti-vortex member 40 and constrained to rotate with the shaft 14.

The pitch of the secondary screw 50 is the opposite to the pitch of the main screw 13.

The means for aerating the surface of the liquid 3 further comprise an anti-vortex member 51 disposed above the secondary screw 50 and inside a cylindrical chimney 52.

The chimney 52 is fixed to the internal edges of the reinforcing ribs 48 to form passages 55 for the liquid 3 in conjunction with the duct 12 and said reinforcing ribs 48.

The secondary screw 50 and the anti-vortex member 51 are situated between the two series of windows 21 and 22 and the chimney 52 extends substantially from the middle of the first series of windows 21 to the upper edge of the second series of windows 22.

A cover 53 is mounted on the shaft 14 above the upper edge of the chimney 52.

The vertical position of the cover 53 is adjustable to form an adjustable passage 54 in conjunction with the upper edge of the chimney 52.

The rotation of the main screw 13 causes aspiration of the liquid 3 through the windows 21 and 22 as a result of which the liquid 3 flows upward in the duct 12.

Accordingly, some of the liquid 3 is aspirated into the duct 12 through the windows 22 and some of the liquid 3 is aspirated through the windows 21 and flows downward in the passages 55 formed between the chimney 52 and the duct 12.

Moreover, because the pitch of the secondary screw 50 is the opposite of the pitch of the main screw 13, some of the liquid is aspirated upward into the chimney 52 and is sprayed into the air at the surface of the liquid 3 inside the funnel 11 on passing through the passage 54.

Spraying some of the liquid therefore incorporates air into the liquid and, moreover, reduces the formation of foam on the surface of the liquid.

The anti-vortex member 51 prevents rotation of the liquid in the chimney 52 above the secondary screw 50.

In this variant the flowrate of the liquid 3 in the duct 12 can be adjusted by moving the sleeves 25 and 26 relative to the windows 21 and 22.

In a fourth embodiment shown in FIGS. 8 to 10, the device according to the invention comprises a vortex pump 60 for aspirating liquid at the surface into the inside of the duct 12.

The vortex pump 60 is disposed above the second anti-vortex member 40 and at the level of the first series of windows 21.

The vortex pump 60 is driven in rotation by the shaft 14 and comprises, firstly, a circular plate 61 fixed to the shaft 14 and provided on its upper face with radial and vertical vanes 62 and, secondly, a chimney 63 fixed to the upper edge of said vanes 62.

The assembly constituted of the plate 61, the vanes 62, and the chimney 63 is retained to the shaft 14 by means of a sleeve 61a whose vertical position on the shaft 14 is adjustable.

The sleeve 61a is fixed to said shaft 14 by means of a member consisting of a fixing screw, not shown, for example.

As shown in FIGS. 8 and 9, the upper edge of the vanes 62 is equipped with a ring 64 extending toward the exterior of the chimney 63.

The chimney 63 extends toward the top of the vessel 1, substantially from the middle of the first series of windows 21 to the upper edge of the vanes 62.

The chimney 63 forms an internal passage 65 whose lower portion communicates with the interior of the duct 12 via annular passages 66 formed between the vanes 62, the ring 64, and the plate 61.

The chimney 63 is preferably conical with the narrower end facing toward the top of the vessel 1, as shown in FIG. 9.

In a variant, the chimney 63 can be cylindrical.

The vanes 62 are plane or curved and there are preferably three of them, regularly distributed over the plate 61, as shown in FIG. 10.

The rotation of the main screw 13 causes aspiration of the liquid 3 into the duct 12 through the windows 21 and 22 and the liquid 3 flows continuously downward in the duct 12.

Moreover, the rotation of the vortex pump 60 driven by the shaft 14, i.e. the rotation of the assembly constituted of the plate 61, the vanes 62, and the chimney 63, causes aspiration of the liquid 3 at the surface into the passage 65, with the result that the liquid then passes through the annular passages 66 and is reinjected into the vessel 1.

In this embodiment, adjustment of the flowrate of the liquid by the sleeves 25 and 26 inside the duct 12 is not necessary.

Because of the effect of the vortex pump 60, the liquid 3 is subjected to violent agitation, encouraging the incorporation of air into the liquid.

This embodiment is particularly suitable for very foamy products because the foam floating on the surface of the liquid 3 is aspirated by the vortex pump 60, which eliminates the foam quickly and efficiently.

A fifth embodiment of the device according to the invention, shown in FIGS. 11 and 12, comprises a single-passage screw 70 for aspirating the liquid 3 into the interior of the duct 12.

The single-passage screw 70 is disposed above the second anti-vortex member 40 and at the level of the first series of windows 21.

The single-passage screw 70 is driven in rotation by the shaft 14 and comprises, firstly, a circular plate 71 fixed to the shaft 14 and disposed above the level of the liquid 3 in the vessel 1 and, secondly, inside the liquid 3, a vertical plate 72 forming a spiral around the shaft 14 and fixed to the lower face of said plate 71.

As shown more particularly in FIG. 12, the plate 72 delimits a lateral inlet 73 for the liquid extending the whole height of said plate 72, a vertical passage 74 in which the liquid flows downward, and a bottom outlet 75 for said liquid.

The assembly constituted of the plate 71 and the vertical plate 72 is retained to the shaft 14 by means of a sleeve 71a whose vertical position on the shaft 14 can be adjusted.

To this end, the sleeve 71a is fixed to said shaft 14 by means of a member constituted of a fixing screw, not shown, for example.

The internal edge of the vertical plate 72 includes a vertical deflector 76 inclined in the direction of the center of the spiral formed by said plate 72.

The distance between the plate 72 and the axis of the shaft 14 decreases progressively, as shown in FIG. 12.

The rotation of the single-passage screw 70 driven by the shaft 19, i.e. the rotation of the assembly constituted of the plate 71 and the plate 72 in the direction indicated by the arrow in FIG. 12, causes aspiration of the liquid into the interior of said plate 72 via the lateral inlet 73.

The liquid is stirred inside the vertical passage 74, flows downward in the passage 74, and is evacuated into the interior of the duct 12 via the lower outlet 75.

The deflector 76 improves the stirring of the liquid inside the vertical passage 74 and prevents the liquid from returning via the lateral inlet 73.

The stirring effected by the single-passage screw 70 encourages the incorporation of air into the liquid 3.

A sixth embodiment of the device according to the invention, shown in FIGS. 13 and 14, comprises a two-passage screw 80 for aspirating the liquid 3 into the interior of the duct 12.

The two-passage screw 80 is disposed above the second anti-vortex member 40 and at the level of the first series of windows 21.

The two-passage screw 80 is driven in rotation by the shaft 14 and comprises, firstly, a circular plate 81 fixed to the shaft 14 and disposed above the level of the liquid 3 in the vessel 1 and, secondly, two vertical plates 82 and 83 inside the liquid 3.

The vertical plates 82 and 83 are fixed to the lower face of the plate 80 and each takes the form of two half-shells opposite and spaced from each other, as shown in FIG. 14.

The two plates 82 and 83 delimit two lateral inlets 84 and 85 for the liquid, two passages 86 and 87 in which the liquid flows downward, and a lower outlet 88 for said liquid.

The assembly constituted of the plate 81 and the vertical plates 82 and 83 is retained to the shaft 14 by means of a sleeve 81a whose vertical position on the shaft 14 can be adjusted.

The sleeve 81a is fixed to the shaft 14 by means of a member constituted of a fixing screw, not shown, for example.

As shown more particularly in FIG. 14, the edge of each plate 82 and 83 facing the passage 86 or 87 delimited by the other plate includes a respective vertical deflector 89, 90.

The rotation of the two-passage screw 80 driven by the shaft 14, i.e. the rotation of the assembly constituted of the plate 81 and the two vertical plates 82 and 83 in the direction indicated by the arrow in FIG. 14, causes aspiration of the liquid 3 through the windows 21.

The liquid enters via the lateral inlets 84 and 85, is stirred inside the passages 86 and 87, flows downward inside the passages 86 and 87, and is then evacuated into the duct 12 through the lower outlet 88.

The deflectors 89 and 90 augment the stirring of the liquid inside the passages 86 and 87 and prevent the liquid flowing back through the lateral inlets 84 and 85.

The effect of stirring by the two-passage screw 80 encourages incorporation of air into the liquid 3.

In these last two embodiments, adjustment of the flowrate of the liquid by the sleeves 25 and 26 of the duct 12 is not necessary and these last two embodiments are more particularly used in situations where the level of liquid inside the vessel 1 varies.

A pumping screw (not shown) can be disposed on the shaft 14 below the single-passage screw or the two-passage screw to improve the flowrate of the single-passage screw 70 or the two-passage screw 80.

The device according to the invention is applied, for example, to treatment of water, urban effluent, industrial waste water, greases by biological degradation, drainage materials, livestock waste, and generally to all biodegradable industrial products.

Of course, the present invention is not limited to the embodiments described and shown, which are provided by way of illustrative and nonlimiting example.

1. A device (10) for stirring and aerating a liquid (3) in a treatment vessel (1), comprising:
at least one funnel (11) adapted to be disposed in the upper portion of said vessel (1) and forming with said vessel (1) a passage (11a),
at least one duct (12) connected to said funnel (11) and adapted to extend in the direction of the bottom of said vessel (1), said duct (12) including at least one opening (12a, 12b) in each of its upper and lower portions,
at least one main screw (13) situated in said duct (12),
means (14, 15) for driving rotation of said screw (13), and
means (17, 18; 21; 40; 45, 46, 47; 50, 51, 52; 60; 70; 80) for incorporating air into said liquid, said air incorporation means being constituted exclusively of means adapted to incorporate air at atmospheric pressure into said liquid (3) exclusively because of the effect of imparting movement to said liquid (3) inside said device (10),
characterized in that said air incorporation means comprise the upper edge of said funnel (11), conformed to form a cascade of liquid (3) at the periphery of said funnel (11).

2. A device (10) according to claim 1, characterized in that said funnel (11) has a substantially conical bottom (11b) surmounted by a substantially cylindrical belt (11c) defining said edge.

3. A device (10) according to either claim 1 or claim 2, characterized in that said air incorporation means comprise a plurality of projections (17) distributed on the upper edge of said funnel (11).

4. A device (10) according to any one of claims 1 to 3, characterized in that said air incorporation means comprise an annular member (18) inside said funnel (11).

5. A device (10) according to claim 4, characterized in that said annular member (18) takes the form of an annular trough.

6. A device (10) according to claim 4, characterized in that said annular member (18) takes the form of an annular grid.

7. A device (10) according to any one of the preceding claims, characterized in that said duct (12) extends above the upper edge of said funnel (11) and said air incorporation means comprise at least one window (21) formed in the upper portion of said duct (12).

8. A device (10) according to any one of the preceding claims, characterized in that said air incorporation means comprise anti-vortex means (40) disposed inside said duct (12) above said main screw (13).

9. A device (10) according to any one of the preceding claims, characterized in that said air incorporation means comprise an accelerator (45, 46, 47) of the liquid (3) inside said duct (12).

10. A device (10) according to any one of the preceding claims, characterized in that said air incorporation means comprise means (50, 51, 52) for aerating the surface of said liquid (3).

11. A device (10) according to any one of the preceding claims, characterized in that said air incorporation means comprise a vortex pump (60) inside said duct (12).

12. A device (10) according to any one of the preceding claims, characterized in that said air incorporation means comprise a single-passage screw (70) inside said duct (12).

13. A device (10) according to any one of the preceding claims, characterized in that said air incorporation means comprise a two-passage screw (80) inside said duct (12).

14. A device (10) according to any one of the preceding claims, characterized in that said main screw (13) is of the mainly axial flow type.

15. A device (10) according to any one of the preceding claims, characterized in that it includes anti-vortex means (40) disposed inside said duct (12) below said main screw (13).

16. A device (10) according to any one of the preceding claims, characterized in that it comprises dynamic stirring means.

17. A device (10) according to any one of claims 1 to 15, characterized in that it comprises static stirring means (30) for creating turbulence disposed inside said duct (12).

18. A device (10) according to any one of the preceding claims, characterized in that it comprises means for aspirating foam (23) formed on the surface of said liquid (3) into the interior of said duct (12).

19. A liquid treatment vessel (1), characterized in that it is equipped with a device (10) according to any one of the preceding claims.
